(19) United States
(12) Patent Application Publication
(10) Pub. No.: US 2013/0096913 A1
(43) Pub. Date: Apr. 18, 2013

(54) METHOD AND APPARATUS FOR ADAPTIVE MULTI RATE CODEC

(71) Applicants: Stefan BRUHN, Sollentuna (SE); Jingming Kuang, Beijing (CN); Jing Wang, Beijing (CN); Chunling Zhang, Beijing (CN); Shenghui Zhao, Beijing (CN)

(72) Inventors: Stefan BRUHN, Sollentuna (SE); Jingming Kuang, Beijing (CN); Jing Wang, Beijing (CN); Chunling Zhang, Beijing (CN); Shenghui Zhao, Beijing (CN)

(73) Assignee: TELEFONAKTIEBOLAGET L M ERICSSION (publ), Stockholm (SE)

(21) Appl. No.: 13/307,484

(22) Filed: Nov. 30, 2011

Related U.S. Application Data
(63) Continuation of application No. PCT/CN2011/001730, filed on Oct. 18, 2011.

(51) Int. Cl. G10L 19/04

(52) U.S. Cl. 704/219; 704/E19.023

(57) ABSTRACT

There is provided an apparatus and method for encoding a speech signal. The encoding comprises: receiving a plurality of current samples of the speech signals; extrapolating a plurality of look-ahead samples from the current samples; and performing linear prediction analysis using the current samples and the extrapolated look-ahead samples.

### TECHNICAL FIELD

The present application relates to a method of encoding a speech signal, an apparatus for encoding a speech signal, and a computer-readable medium.

### BACKGROUND

Many speech codecs adopt the framework of Code Excited Linear Prediction (CELP). CELP requires to the use of Linear Prediction (LP) analysis. In some speech codecs, speech samples in the next frame are utilized during the LP analysis of the current frame. The samples from the next frame that are referred to are called the look-ahead samples. Because the encoder must wait for the look-ahead samples to be created, and to arrive at the processor, before coding of the current samples, the look-ahead process inherently creates a delay at least as long as the period of time over which the look-ahead samples span, which is referred to as the look-ahead period.

For example, the coding scheme for the Adaptive Multi-Rate (AMR) coding modes is the Algebraic Code Excited Linear Prediction (ACELP).

The sampling rate for AMR-narrow band (AMR-NB) is 8000 samples per second. The coded bit rate is dependent on the mode. Currently used coding modes are: 4.75, 5.15, 5.90, 6.70, 7.40, 7.95, 10.2 and 12.2 kbits/s. In AMR-NB, the short term filter coefficients are computed using the high-pass filtered speech samples within the analysis window for each frame. The length of the analysis window is 240 samples.

In the 12.2 kbits/s mode, two asymmetric windows are used to generate two sets of LP coefficients for each frame. No samples of the next frame are used (there is no look-ahead). In the other modes, only a single asymmetric window is used to generate a single set of LP coefficients, and this window has a 40 sample look-ahead, which means a 5 ms look-ahead period.

In the AMR-Wideband (AMR-WB) the sampling rate is 16000 samples per second, but the processing rate is reduced to 12800 samples per second. The coded bit rate is dependent on mode. Currently used coding modes are 6.60, 8.85, 12.65, 14.25, 15.85, 18.25, 19.85, 23.05 and 23.85 kbits/s. In AMR-WB, the length of the analysis window is 384 samples. For all the modes, a single asymmetric window is used to generate a single set of LP coefficients. This window has a 64 sample look-ahead, which requires a 5 ms look-ahead period at the processing rate of 12800 samples per second.

A window including some look-ahead samples is used in the above examples because the quality of the resulting coded speech is significantly improved, as compared to a window with no look-ahead.

In the LP model of AMR-NB, when encoding a frame (the current frame) the first 40 samples of the subsequent frame must be analyzed. Similarly, in the LP model of AMR-WB, when a current frame is being encoded the first 64 samples of the next frame must be examined. In both cases the look-ahead period is 5 ms. This look-ahead period causes a delay which increases the overall transmission delay. Such delays degrade the Quality of Service for speech communication and may reduce the system capacity.

The look-ahead period of 5 ms is thus a compromise between coded speech quality and transmission delay. There is a need for an improved method and apparatus for both the AMR codec, and for codecs that use look-ahead samples in general.

The AMR Speech Codec and transcoding functions are described in 3GPP Technical Specification 26.090 v10.0.0, incorporated herein by reference. The Adaptive Multi-Rate-Wideband (AMR-WB) speech codec and respective transcoding functions are described in 3GPP TS 26.190 v 10.0.0, incorporated herein by reference. A further description of AMR can be found in “Source signal based rate adaptation for GSM AMR speech codec by J. Makinen and J. Vainio, published in Information Technology: Coding and Computing (ITCC), 2004, incorporated herein by reference. More information on linear prediction can be found in “Gradient-Descent Based Window Optimization for Linear Prediction Analysis” by W. C. Chu, published in IEEE ICASSP, Hong Kong, April 2003, incorporated herein by reference. More information on windows for sampling can be found in “Window Optimization in Linear Prediction Analysis” by Wai C. Chu, published in IEEE TRANSACTIONS ON SPEECH AND AUDIO PROCESSING, VOL. 11, NO. 6, NOVEMBER 2003.

### SUMMARY

The methods and apparatus described herein provide a way to skip the look-ahead period, improving quality of service on the transmission system, without significantly affecting the quality of the coded speech. This is done by using a sampling window for linear prediction that still requires look-ahead samples, but instead of waiting for the look-ahead samples to be created and to arrive at the processor, the look-ahead samples are extrapolated from the currently available samples. The extrapolated samples take the place of the look-ahead samples in the linear prediction analysis.

The method and apparatus provided herein have been found to provide a coded speech quality that is significantly improved upon a system using a sampling window having no look-ahead.

Accordingly, there is provided a method of encoding a speech signal. The method comprises receiving a plurality of current samples of the speech signals. The method further comprises extrapolating a plurality of look-ahead samples from the current samples. The method further comprises performing linear prediction analysis using the current samples and the extrapolated look-ahead samples.

Look-ahead values increase the quality of the encoding process, but waiting for the look-ahead values to arrive at the encoder causes delay in the encoding process. By extrapolating the look-ahead samples from current samples, this delay is avoided, and the quality of encoding is found to still be greater than if no look-ahead samples are considered. The method may comprise encoding the plurality of current samples by performing linear prediction analysis using the current samples and the extrapolated look-ahead samples.

The linear prediction analysis may be used to construct linear predictive filters for each of a plurality of subframes. The linear predictive filters are linear filters used by a linear predictive encoder. The linear predictive filters may comprise synthesis filters, weighting filters or analysis filters.

The linear prediction analysis may be performed using an autocorrelation method. The method may further comprise converting the auto-correlations of the speech signal to Linear Prediction coefficients using the Levinson-Durbin algorithm. The method may further comprise transforming the Linear prediction coefficients to the Line Spectral Pair domain for quantization and interpolation purposes. The interpolated quantified and unquantized filter coefficients may be converted back to the Linear Prediction filter coefficients.

This may be done to construct synthesis and weighting filters for each of a plurality of subframes.

Alternatively, the linear prediction analysis may alternatively use a covariance method.

The extrapolation of look-ahead samples may comprise a linear prediction technique such as autocorrelation. The auto-correlations of windowed speech may be converted to Linear Prediction coefficients using the Levinson-Durbin algorithm. Then the Linear Prediction coefficients are used to predict future samples, that is, calculate the look-ahead samples.

The extrapolation of look-ahead samples may comprise a linear prediction technique such as covariance. Covariance is applied to the speech samples to generate Linear Prediction coefficients. The Linear Prediction coefficients are used to predict future samples, that is, calculate the look-ahead samples.

There is further provided an apparatus for encoding a speech signal, the apparatus comprising a receiver, an extrapolator, and an encoder. The receiver is arranged to receive a plurality of current samples of the speech signal. The extrapolator is arranged to extrapolate a plurality of look-ahead samples from the current samples. The encoder is arranged to perform linear prediction analysis using the current samples and the extrapolated look-ahead samples.

The apparatus may be further arranged to convert the auto-correlations of the speech signal to Linear Prediction coefficients using the Levinson-Durbin algorithm. The apparatus may be further arranged to transform the Linear prediction coefficients to the Line Spectral Pair domain for quantization and interpolation purposes. The interpolated quantified and unquantized filter coefficients may be converted back to the Linear Prediction filter coefficients. This may be done to construct synthesis and weighting filters for each of a plurality of subframes.

There is further provided an apparatus for encoding a speech signal, the apparatus comprising a processor arranged to use look-ahead values for linear prediction analysis, the apparatus characterized in that the processor is further arranged to extrapolate the look-ahead samples are extrapolated from a plurality of current samples.

There is further provided a computer-readable medium, carrying instructions, which, when executed by computer logic, causes said computer logic to carry out any of the methods defined above.

### BRIEF DESCRIPTION OF THE DRAWINGS

An improved method and apparatus for the AMR codec, and codecs that use look-ahead samples in general, will now be described, by way of example only, with reference to the accompanying drawings, in which:

FIG. 1 is a flow chart of the original linear prediction (LP) analysis model used in a typical AMR encoder;

FIG. 2 shows a graph illustrating a window that may be used in the windowing and autocorrelation process of the linear prediction analysis;

FIG. 3 is a flow chart of the linear prediction (LP) analysis method proposed herein;

FIG. 4 is a flow chart of the method disclosed herein, wherein autocorrelation is used to extrapolate the look-ahead samples from the received samples;

FIG. 5 is a flow chart of the method disclosed herein, wherein covariance is used to extrapolate the look-ahead samples from the received samples;

FIG. 6 shows an apparatus for implementing the methods described herein; and

FIG. 7 shows the method implemented in the apparatus of FIG. 6.

### DETAILED DESCRIPTION

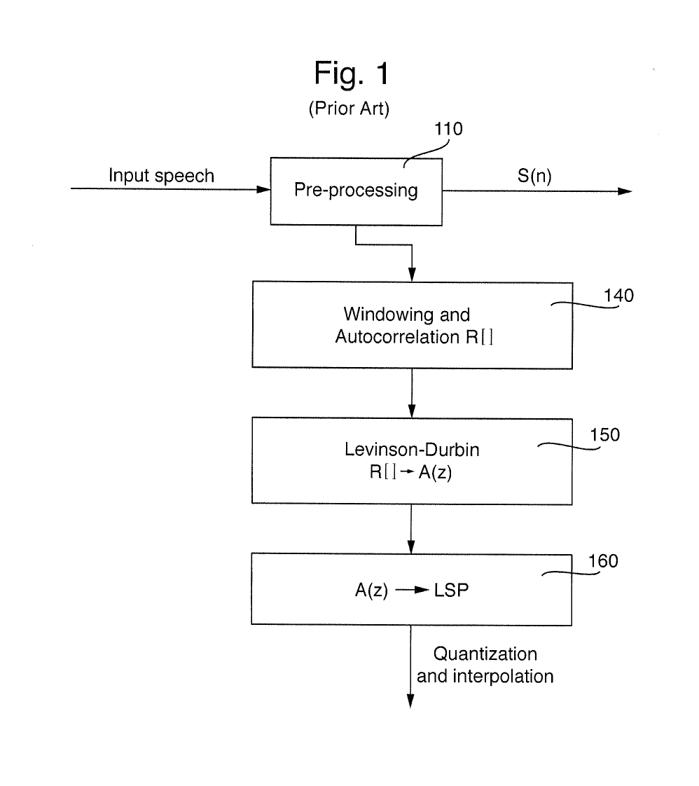

FIG. 1 is a flow chart of the original linear prediction (LP) analysis model used in a typical AMR encoder. At 110, an input speech signal is received, this is pre-processed and sampled. After pre-processing, at 140 the speech samples are windowed to calculate the autocorrelation coefficient R[ ]. Then, at 150 the LP coefficients α_tmp are calculated by the application of the Levinson-Durbin algorithm and using the autocorrelation coefficient R[ ]. Then, at 160, the LP coefficients α_tmp are converted to the Line Spectral Pair (LSP) domain for quantization and interpolation.

Subsequently, and not shown in FIG. 1, the interpolated quantified and unquantized filter coefficients are converted back to the LP filter coefficients (to construct the synthesis and weighting filters at each sub-frame). In AMR-NB one frame consists of 160 samples and so has duration of 20 ms. Each frame consists of 4 sub-frames of 40 samples and duration 5 ms.

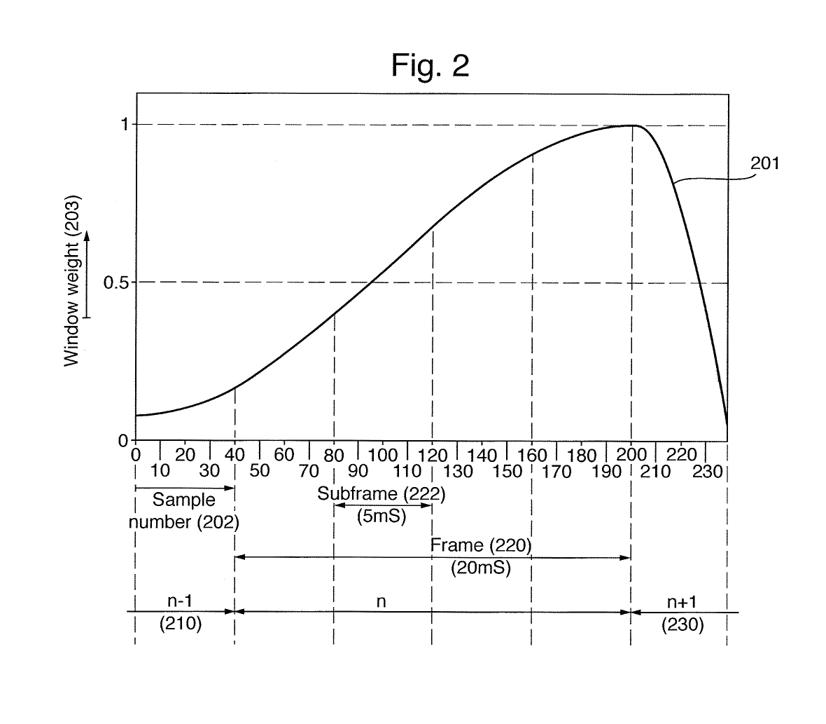

FIG. 2 shows a graph 201 illustrating the relationship between sample number 202 and window weight 203 for a window that may be used in the windowing and autocorrelation process of the linear prediction analysis. The window shown is that used in AMR-NB for the lower bitrate modes (all except 12.2 kbit/s) and is described at section 5.2.1 of 3GPP TS 26.090 v 10.0.0. The window spans 240 samples, numbered 0 to 239, over 3 frames, numbered n−1 (210), n (220), n+1 (230). Frame n, 220 is the current frame. Each frame consists of 160 samples and has duration 20 ms. Each frame consists of 4 sub-frames 222 each having 40 samples and duration 5 ms. The window uses the samples from the current frame 220, the samples from the last sub-frame of the preceding frame 210, and the samples from the first sub-frame of the subsequent frame 230.

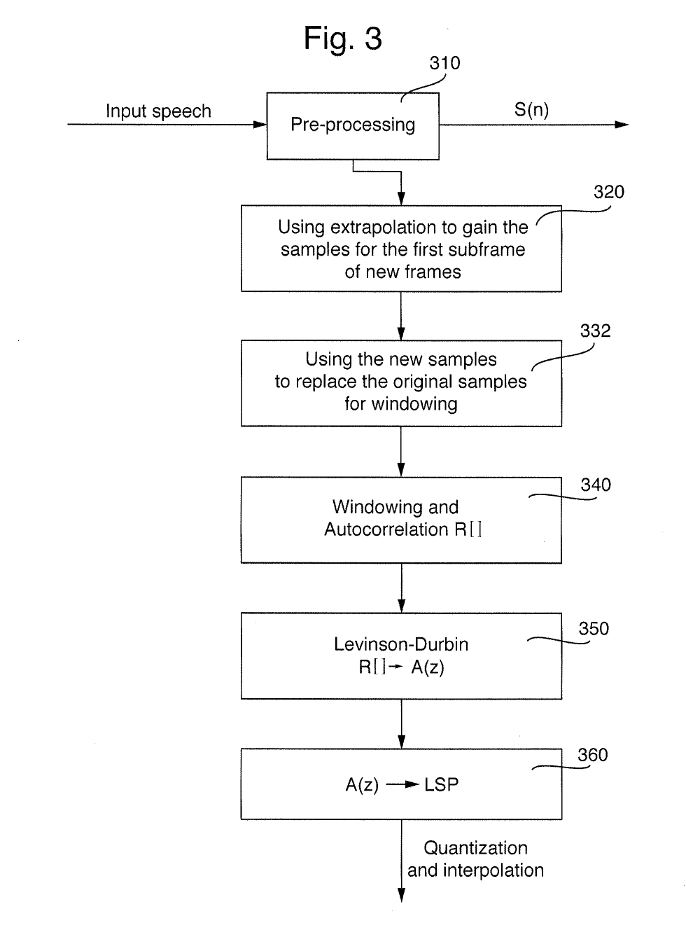

FIG. 3 is a flow chart of the linear prediction (LP) analysis method proposed herein. At 310, an input speech signal is received, this is pre-processed and sampled. After pre-processing, at 320 extrapolation is used to derive look-ahead samples from the received samples. At 332, the original look-ahead samples, which have not yet arrived, are replaced by the extrapolated look-ahead samples produced at 320. The LP analysis may then proceed using the extrapolated look-ahead samples, starting at 340 where the appropriate received and extrapolated speech samples are windowed to calculate the autocorrelation coefficient R[ ]. Then, at 350 the LP coefficients α_tmp are calculated by the application of the Levinson-Durbin algorithm and using the autocorrelation coefficient R[ ]. Then, at 360, the LP coefficients α_tmp are converted to the Line Spectral Pair (LSP) domain for quantization and interpolation.

According to the AMR-NB algorithm, each subframe consists of 40 samples, and the look-ahead for all modes except the 12.2 kbit/s mode is 40 samples. Thus, when the method disclosed herein is applied to a system using AMR-NB, 40 look-ahead samples are extrapolated from the received samples for use in the Linear Prediction analysis. These extrapolated samples replace the samples from the next frame used in the original method and thus the 5 ms delay caused by waiting for these is removed.

Similarly, according to the AMR-WB algorithm, each sub-frame is 64 samples, and the look-ahead for Linear Prediction analysis comprises one sub-frame of samples. Thus, when the method disclosed herein is applied to a system using AMR-WB, 64 look-ahead samples are extrapolated from the received samples for use in the Linear Prediction analysis. These extrapolated samples replace the samples from the next frame used in the original method and thus the 5 ms delay caused by waiting for these is removed.

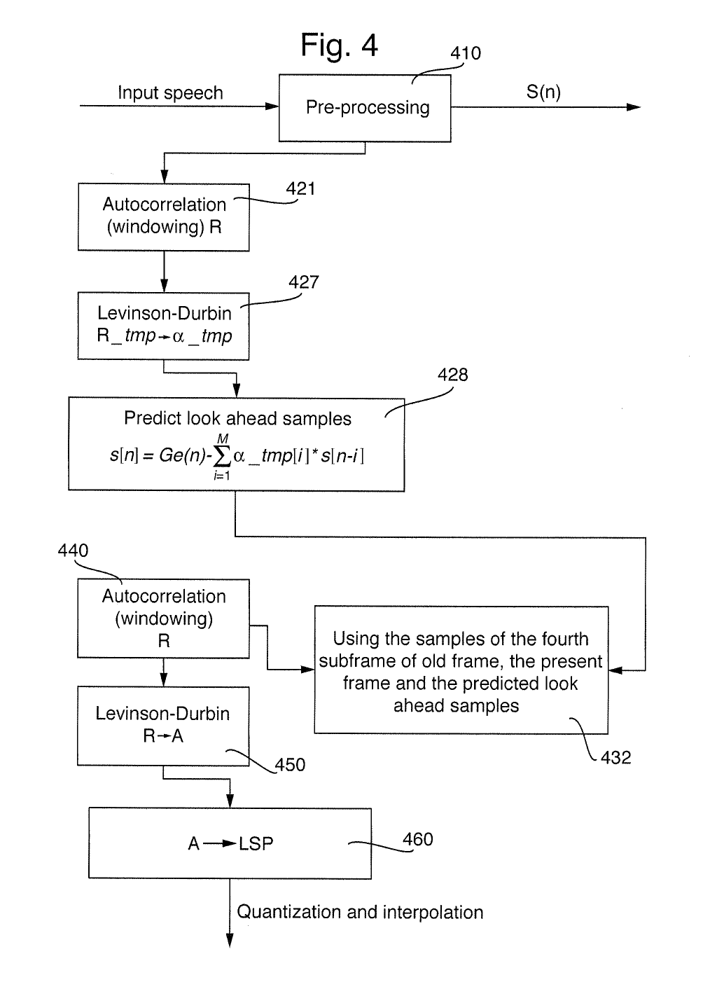

FIG. 4 is a flow chart of the method disclosed herein, wherein autocorrelation is used to extrapolate the look-ahead samples from the received samples. At 410, an input speech signal is received, this is pre-processed and sampled. After pre-processing, the extrapolation of look-ahead samples begins at 421 with autocorrelation and windowing. The autocorrelation at 421 uses a window with no look-ahead; the window contains only the samples of the current frame and the samples of the last two subframes of the previous frame. At 421 the autocorrelation coefficient R[ ] is calculated for the samples identified by the window. Then, at 427 the LP coefficients α_tmp are calculated by the application of the Levinson-Durbin algorithm and using the autocorrelation coefficient R[ ]. The LP coefficients α_tmp are then used to calculate the extrapolated look-ahead samples s[n] at 428, using the formula shown in box 428 of FIG. 4.

At 432, the original (or “real-world”) look-ahead samples, which have not yet been received, are replaced by the extrapolated look-ahead samples calculated at 428. The LP analysis for speech coding may then proceed using both the received samples and, in place of the original look ahead samples, the extrapolated look-ahead samples. The LP analysis for speech coding begins at 440 where the appropriate current samples and extrapolated samples are windowed and the autocorrelation coefficient R[ ] for the selected samples is calculated. Then, at 450 the LP coefficients α_tmp for these samples are calculated by the application of the Levinson-Durbin algorithm and using the autocorrelation coefficient R[ ]. Then, at 460, the LP coefficients α_tmp are converted to the Line Spectral Pair (LSP) domain for quantization and interpolation. The encoding process then proceeds as described above.

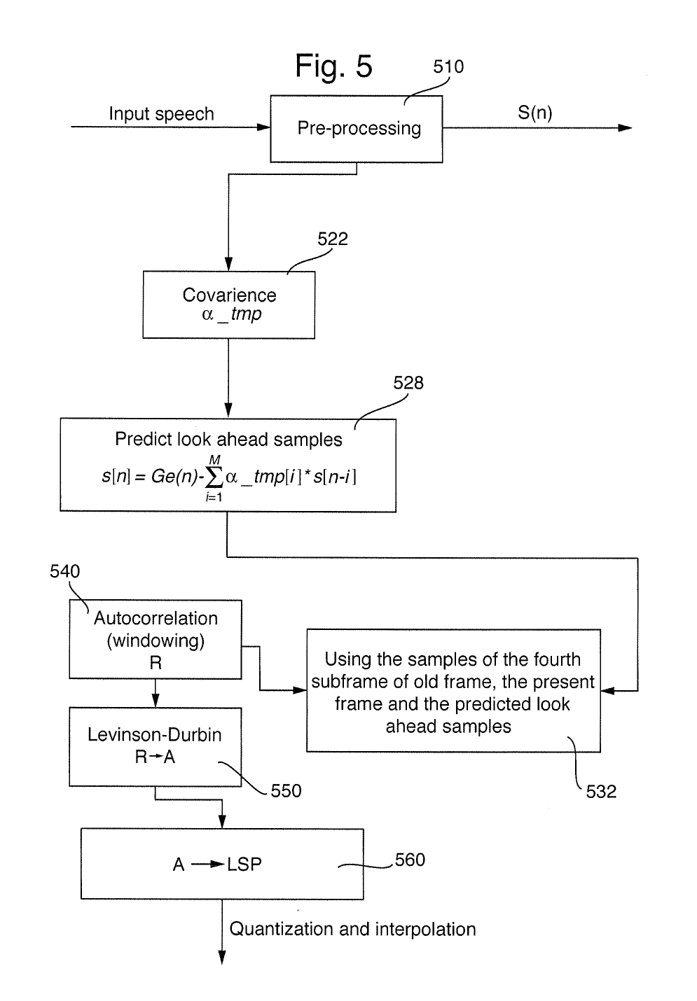

FIG. 5 is a flow chart of the method disclosed herein, wherein covariance is used to extrapolate the look-ahead samples from the received samples. At 510, an input speech signal is received, this is pre-processed and sampled. After pre-processing, the extrapolation of look-ahead samples begins at 522 with a covariance method. The covariance at 522 uses no look-ahead window; the window contains only the samples of the current frame. At 522 the LU decomposition is used to calculate LP coefficients α_tmp. The LP coefficients α_tmp are then used to calculate the extrapolated look-ahead samples s[n] at 528, using the formula shown in box 528 of FIG. 5. The number of look-ahead samples that are extrapolated is dependent upon the window of the LP analysis. At least some of the samples required for the linear prediction analysis are extrapolated from the received samples.

At 532, the original (or “real-world”) look-ahead samples, which have not yet been received, are replaced by the extrapolated look-ahead samples calculated at 528. The LP analysis for speech coding may then proceed using both the received samples and, in place of the original look ahead samples, the extrapolated look-ahead samples. The LP analysis for speech coding begins at 540 where the appropriate current samples and extrapolated samples are windowed and the autocorrelation coefficient R[ ] for the selected samples is calculated. Then, at 550 the LP coefficients α_tmp for these samples are calculated by the application of the Levinson-Durbin algorithm and using the autocorrelation coefficient R[ ]. Then, at 560, the LP coefficients α_tmp are converted to the Line Spectral Pair (LSP) domain for quantization and interpolation. The encoding process then proceeds as described above.

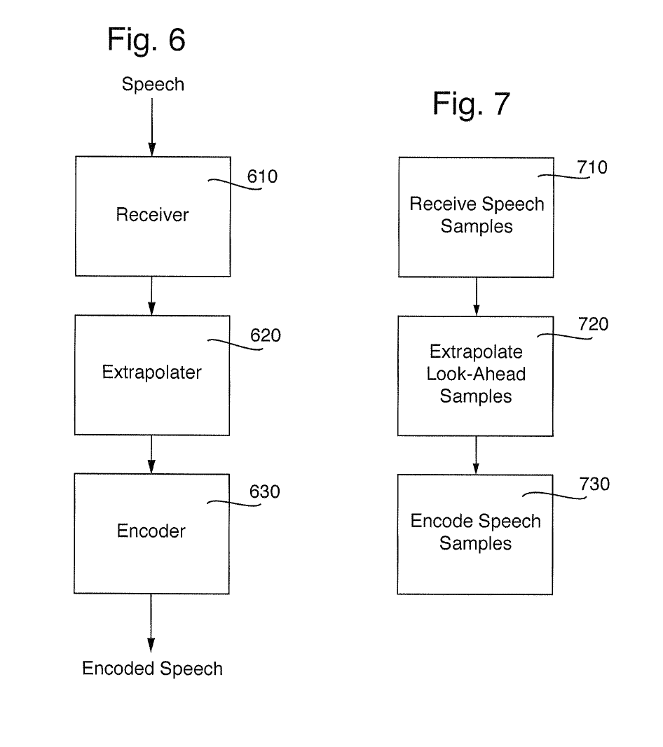

FIG. 6 shows an apparatus for implementing the methods described herein. The apparatus comprises a receiver 610 and an extrapolator 620 and an encoder 630. The receiver 610 receives a speech signal. The receiver 610 performs pre-processing to create a plurality of samples. The extrapolator 620 receives the samples and applies an extrapolation method to the received samples to create extrapolated look-ahead samples. Then the encoder 630 encodes the speech samples on a frame by frame basis. As part of the encoding process the processor 620 uses linear prediction analysis, with an associated at least one window of samples. Where the window includes look-ahead samples, conventionally from a subsequent frame, the extrapolated look-ahead samples are used in their place.

The generic method implemented in the apparatus of FIG. 6 is shown in FIG. 7. At 710 speech samples are received. The speech samples result from the pre-processing of an input speech signal. At 720 look-ahead samples are extrapolated from the received samples. The extrapolation may comprise the application of an auto-correlation method, a covariance method, or another extrapolation method. At 730 the current speech samples are encoded. The encoding uses both the received speech samples and the extrapolated speech samples to perform linear prediction analysis in respect of the current frame of speech samples.

The linear prediction analysis gives LP coefficients, which are converted to the Line Spectral Pair (LSP) domain for quantization and interpolation. Subsequently, the interpolated quantified and unquantized filter coefficients are converted back to the LP filter coefficients (to construct the synthesis and weighting filters at each sub-frame).

According to some embodiments, all look-ahead samples are replaced by extrapolated samples, extrapolated from the received samples. The above method may be equally applied to a proportion of the look-ahead samples. For example, the encoder may wait to receive the first half of the look-ahead samples from the input speech signal, and extrapolate samples to replace the second half. In this example the look-ahead delay is reduced by half. more generally, the look-ahead delay is reduced by the proportion of the samples that are extrapolated from received samples. Extrapolation is used to calculate the latter proportion of the required look-ahead samples That is, those that have not been received once the first proportion has been received.

It has been found that the above described method of using extrapolation to skip some look-ahead can decrease the 5 ms look-ahead delay for AMR speech codec, and that the obtained speech quality is near to that of the conventional method.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular communications standards, these examples are not intended to be the limit of the communications standards to which the disclosed method and apparatus may be applied. For example, while specific examples have been given in the context of AMR speech coding, the principles disclosed herein can also be applied to any speech coding system which uses look-ahead samples as part of the encoding process.

1. A method of encoding a speech signal, the method comprising:
receiving a plurality of current samples of the speech signals;
extrapolating a plurality of look-ahead samples from the current samples; and
performing linear prediction analysis using the current samples and the extrapolated look-ahead samples.

2. The method of claim 1, further comprising:
receiving a speech signal; and
pre-processing the speech signal to create current samples.

3. The method of claim 1, wherein the linear prediction analysis is used to construct linear predictive filters for each of a plurality of subframes.

4. The method of claim 1, wherein the linear prediction analysis is performed using an autocorrelation method.

5. The method of claim 1, wherein the extrapolation of look-ahead samples uses an autocorrelation method.

6. The method of claim 5, wherein the extrapolation of look-ahead samples using an autocorrelation method comprises calculating an autocorrelation from a plurality of current samples.

7. The method of claim 5, wherein a window is used to determine the current samples that are used to perform the autocorrelation.

8. The method of claim 1, wherein the extrapolation of look-ahead samples uses a covariance method.

9. The method of claim 8, wherein the extrapolation of look-ahead samples using a covariance method comprises calculating a covariance from a plurality of current samples.

10. The method of claim 8, wherein a pre-determined sample length is used to determine the current samples to which the covariance method is applied.

11. A method of encoding a speech signal, the method comprising using look-ahead values for linear prediction analysis, the method characterized in that the look-ahead samples are extrapolated from current samples.

12. An apparatus for encoding a speech signal, the apparatus comprising:
a receiver arranged to receive a plurality of current samples of the speech signal;
an extrapolator arranged to extrapolate a plurality of look-ahead samples from the current samples; and
an encoder arranged to perform linear prediction analysis using the current samples and the extrapolated look-ahead samples.

13. The apparatus of claim 12, wherein the encoder is further arranged to use the linear prediction analysis to construct linear predictive filters for each of a plurality of subframes.

14. The apparatus of claim 12, wherein the encoder is arranged to perform the linear prediction analysis using an autocorrelation method.

15. The apparatus of claim 12, wherein the encoder is further arranged to use an autocorrelation method to generate a filter that is used to extrapolate the plurality of look-ahead samples.

16. The apparatus of claim 15, wherein the encoder is further arranged to calculate an autocorrelation from a plurality of current samples.

17. The apparatus of claim 15, wherein the encoder is arranged to use a window to determine the current samples to which the autocorrelation method is applied.

18. The apparatus of claim 12, wherein the encoder is further arranged to use a covariance method to extrapolate the plurality of look-ahead samples.

19. The apparatus of claim 18, wherein the encoder is further arranged to calculate a covariance from a plurality of current samples.

20. The apparatus of claim 18, wherein the encoder is arranged to use a pre-determined number of current samples for the covariance method.

21. An apparatus for encoding a speech signal, the apparatus comprising a processor arranged to use look-ahead values for linear prediction analysis, the apparatus characterized in that the processor is further arranged to extrapolate the look-ahead samples are extrapolated from a plurality of current samples.

22. A computer-readable medium, carrying instructions, which, when executed by computer logic, causes said computer logic to carry out any of the methods defined by claim 1.
